(19) United States
(12) Patent Application Publication
(10) Pub. No.: US 2020/0295323 A1
(43) Pub. Date: Sep. 17, 2020

(54) BATTERY MODULE AND BATTERY PACK

(71) Applicant: YAZAKI CORPORATION, Tokyo (JP)

(72) Inventors: Keitaro Nozawa, Makinohara-shi (JP); Kimihiro Matsuura, Makinohara-shi (JP); Hidehiko Shimizu, Makinohara-shi (JP); Haruhiko Yoshida, Makinohara-shi (JP); Yuki Chiyajo, Makinohara-shi (JP)

(21) Appl. No.: 16/813,653

(22) Filed: Mar. 9, 2020

(30) Foreign Application Priority Data
Mar. 11, 2019 (JP) 2019-043281

(51) Int. Cl. H01M 2/10; H01M 10/42; H01M 2/12

(52) U.S. Cl. CPC H01M 2/1077; H01M 2/1252; H01M 10/425

(57) ABSTRACT

A battery module includes a cell module including a plurality of battery cells, a smoke exhaust duct protruding from an electrode arrangement surface of the cell module and extending along an alignment direction of the plurality of battery cells, and a circuit board arranged so as to cover the smoke exhaust duct and the electrode arrangement surface. The circuit board is arranged in an inclined state to be non-parallel to the electrode arrangement surface.

### CROSS REFERENCE TO RELATED APPLICATIONS

This application claims priority from Japanese Patent Application No. 2019-043281 filed on Mar. 11, 2019, the entire contents of which are incorporated herein by reference.

### BACKGROUND OF THE INVENTION

### Field of the Invention

The present invention relates to a battery module including a cell module, a smoke exhaust duct, and a circuit board. The present invention also relates to a battery pack including the battery module, a case and a cover for accommodating the battery module.

### Description of Related Art

A battery module of the related art includes a cell module including a plurality of battery cells, a smoke exhaust duct formed so as to protrude from an electrode arrangement surface of the cell module and to extend along an alignment direction of the battery cells, and a circuit board arranged on a side of the electrode arrangement surface (see, for example, the patent document 1: JP-A-2015-41595). The battery module is accommodated in a case and a cover (see, for example, patent document 2: JP-B-5340676).

### Patent Document 1: JP-A-2015-41595

### Patent Document 2: JP-B-5340676

In a related art, a circuit board is arranged in parallel on an electrode arrangement surface. A plurality of openings are arranged side by side at a center of the circuit board. An opening is arranged in accordance with a position of a valve for discharging gas generated inside a battery cell to an outside. The gas passing through the opening is discharged to the outside through a smoke exhaust duct disposed so as to be placed at the central position of the circuit board. Due to an existence of the smoke exhaust duct, a space between the smoke exhaust duct and an electrode becomes a mounting space for electronic components and the like on the circuit board. Therefore, the mounting space for the electronic components and the like is limited. When mounting relatively large components such as a cell voltage monitoring IC which is a main component, there is a problem that the space has to be secured.

Meanwhile, in a related art, a circuit board is arranged and fixed on a smoke exhaust duct. In this case, there is a problem that a height of the entire battery module is increased.

### SUMMARY

One or more embodiments provide a battery module capable of keeping a height low in a state where the circuit board is arranged while securing a component mounting space on the circuit board, and a battery pack including the battery module.

### Solution to Problem

In an aspect (1), one or more embodiments provide a battery module including a cell module including a plurality of battery cells, a smoke exhaust duct protruding from an electrode arrangement surface of the cell module and extending along an alignment direction of the plurality of battery cells, and a circuit board arranged so as to cover the smoke exhaust duct and the electrode arrangement surface. The circuit board is arranged in an inclined state to be non-parallel to the electrode arrangement surface.

According to the aspect (1), since the circuit board is arranged in an inclined state, by mounting a component having a relatively high height at a low position on the circuit board in the inclined state, the height of the entire battery module can be made lower than in the related art. That is, miniaturization and reduction in height can be achieved. Further, according to the present invention, since the circuit board is arranged in the inclined state, it is possible to secure a larger component mounting space on the circuit board than in the related art. If illustrated using a right triangle, the circuit board in the present invention is arranged at a position corresponding to an inclined side of the right triangle, and the circuit board in the related art is arranged at a position corresponding to an adjacent side of the right triangle (an opposite side of the right triangle is a position corresponding to a height of the smoke exhaust duct). In the right triangle, since the length of the inclined side is longer than that of the adjacent side, the circuit board in the present invention has a wider width. That is, the circuit board according to the present invention can secure a larger component mounting space.

In an aspect (2), the circuit board may include a first divided-circuit-board and a second divided-circuit-board in which the circuit board is divided along the alignment direction. A divided portion of the first divided-circuit-board and the second divided-circuit-board may be arranged on an upper end side of the smoke exhaust duct.

According to the aspect (2), since the circuit board is formed in a state where the right triangles exist on both sides of the smoke exhaust duct with the smoke exhaust duct as a center, that is, in an inverted V-shaped cross section, the height can be reduced as compared with the related art, and the larger component mounting space can be secured.

In an aspect (3), the first divided-circuit-board may have a wider width than that of the second divided-circuit-board in a width direction orthogonal to the alignment direction.

According to the aspect (3), since a first divided-circuit-board having a wide width and an second divided-circuit-board having a narrower width than the first divided-circuit-board are provided, even a component having a relatively wide width can be mounted by utilizing the first divided-circuit-board.

In an aspect (4), the first divided-circuit-board and the second divided-circuit-board are connected by connecting circuit body having flexibility.

According to the aspect (4), since the circuit board is formed by a connecting circuit body having flexibility and connecting the first divided-circuit-board and the second divided-circuit-board, the circuit board can be easily formed in the inverted V-shaped cross section.

In an aspect (5), the smoke exhaust duct may have an inclined mounting surface on which the circuit board is arranged in the inclined state and mounted.

According to (5), since an inclined mounting surface is formed in the smoke exhaust duct, the circuit board can be easily arranged in the inclined state.

In an aspect (6), a battery pack may include the battery module according to any one of aspects (1) to (5), a case accommodating the battery module, and a cover covering the case.

According to (6), since the battery module is provided in which the height is kept low in a state where the circuit board is arranged while securing the component mounting space on the circuit board, it is possible to provide a better battery pack.

According to one or more embodiments, it is possible to keep the height low in a state where the circuit board is arranged while securing the component mounting space on the circuit board (miniaturization and reduction in height). Further, according to the battery pack of the present invention, it is possible to provide a better one.

### BRIEF DESCRIPTION OF THE DRAWINGS

FIG. 1 is schematic view showing an embodiment of a battery module and includes a plan view and a cross-sectional view taken along line A-A of the plan view.

FIG. 2 is an enlarged view of FIG. 1.

FIGS. 3A and 3B are explanatory diagrams related to miniaturization and reduction in height. FIG. 3A is a diagram showing the battery module. FIG. 3B is a diagram showing a comparative example 1.

FIGS. 4A, 4B, 4C, and 4D are explanatory diagrams related to securing a component mounting space. FIG. 4A is a diagram showing the battery module. FIG. 4B is a diagram showing a comparative example 2. FIGS. 4C and 4D are explanatory diagrams using a right triangle.

FIG. 5 is a diagram showing a modification of the battery module.

FIG. 6 is a diagram showing another modification of the battery module.

### DETAILED DESCRIPTION

In a battery pack mounted on an automobile, a battery module is accommodated in a case and a cover. The battery module includes a cell module including a plurality of battery cells, a smoke exhaust duct formed so as to protrude from an electrode arrangement surface of the cell module and to extend along an alignment direction of the battery cells, and a circuit board arranged so as to cover the smoke exhaust duct and the electrode arrangement surface. The circuit board is arranged in an inclined state non-parallel to the electrode arrangement surface.

### EMBODIMENT

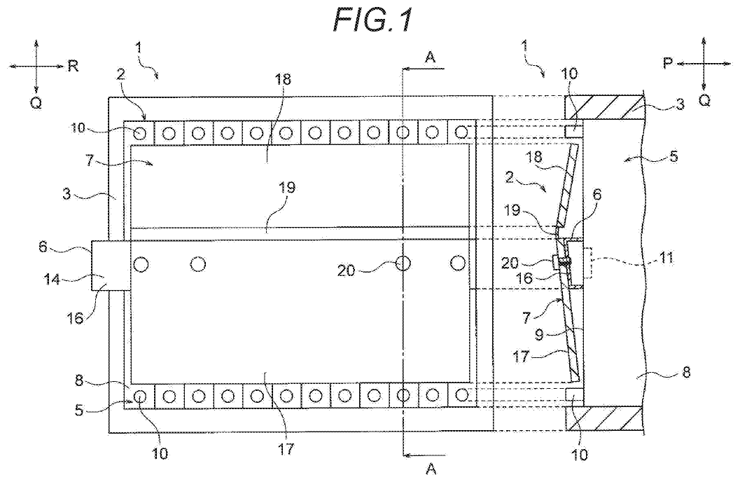

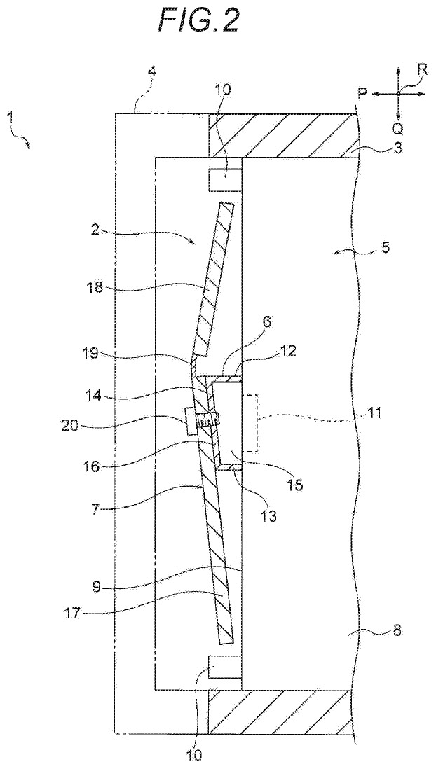

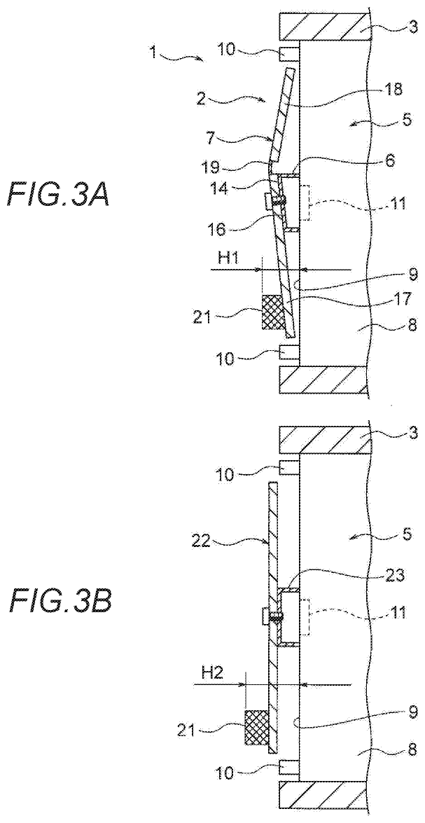

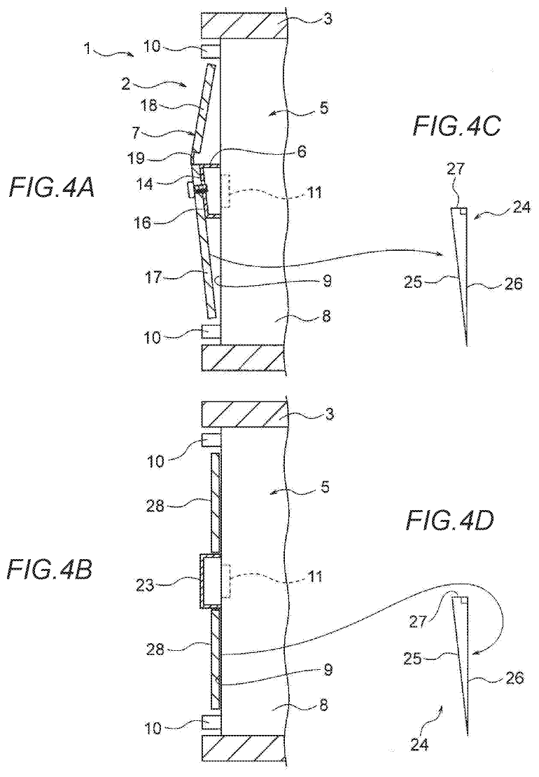

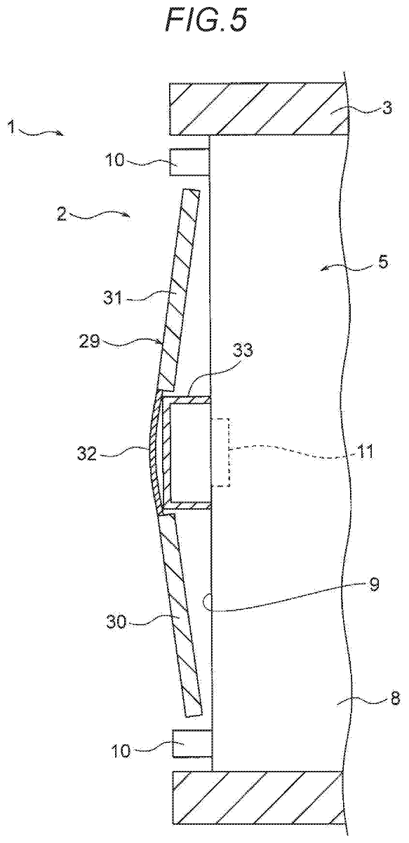

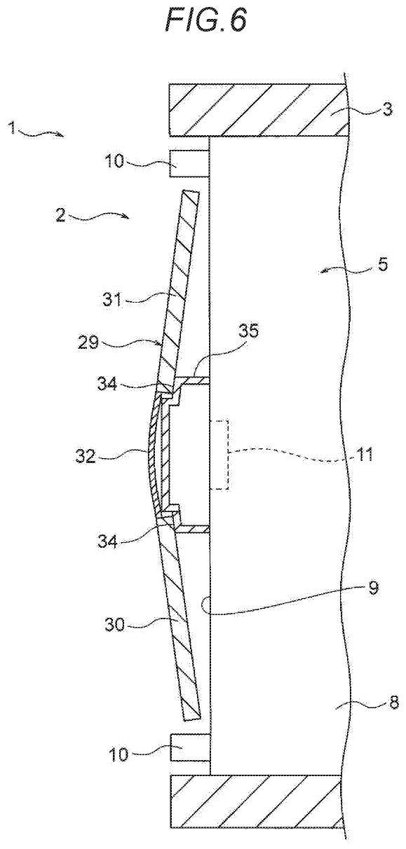

An embodiment will be described below with reference to the drawings. FIG. 1 is schematic views showing an embodiment of a battery module according to the present invention. Further, FIG. 2 is an enlarged view of FIG. 1. FIGS. 3A and 3B are explanatory diagrams related to miniaturization and reduction in height, FIGS. 4A, 4B, 4C, and 4D are explanatory diagrams related to securing a component mounting space. FIGS. 5 and 6 are diagrams showing modifications of the battery module. An arrow P in the drawings indicates an up-down direction (a height direction), an arrow Q indicates a left-right direction (a width direction), and an arrow R indicates a longitudinal direction (an alignment direction disclosed in the claims).

### Battery Pack 1 and Battery Module 2

In FIG. 1 and FIG. 2, the battery pack 1 is mounted on an automobile that requires a high-voltage drive motor, such as an electric vehicle, a hybrid vehicle, and a multi-purpose automatic driving vehicle. The battery pack 1 includes a battery module 2, a case 3 that accommodates the battery module 2, and a cover 4 that covers an opening of the case 3. The battery module 2 includes a cell module 5, a smoke exhaust duct 6, a circuit board 7, and a bus bar module (not shown). Each of the above configurations will be described below.

### Cell Module 5

In FIG. 1, the cell module 5 is formed by arranging a plurality of battery cells 8 in the longitudinal direction of the arrow R (the alignment direction). A separator having insulating property may be provided between the battery cells 8. The battery cell 8 is formed in a rectangular parallelepiped shape such that a width in the longitudinal direction is smaller than dimensions of an up-down height and a left-right width (illustrated shape is an example). An upper surface of the battery cell 8 is formed as an electrode arrangement surface 9 (shown as the electrode arrangement surface 9 having a flat surface in the present embodiment, which may have, for example, a somewhat stepped surface). The battery cell 8 includes two electrodes 10, a valve 11, and an injection hole (not shown) on the electrode arrangement surface 9. The two electrodes 10 are a positive electrode and a negative electrode, which are arranged at a predetermined interval. The two electrodes 10 are arranged near both ends of the electrode arrangement surface 9 in the left-right direction. A bus bar of the bus bar module (not shown) is connected to the positive electrode and the negative electrode, respectively. The electrodes 10 of the adjacent battery cells 8 are connected in series or in parallel by the bus bar of the bus bar module (not shown). The valve 11 is arranged at a center position of the electrode arrangement surface 9 in the left-right direction. The valve 11 is provided as a portion for discharging gas generated inside the battery cell 8 to the outside of the battery cell 8 (for exhausting smoke). The valve 11 is formed in a mechanism portion that can be opened when an internal pressure of the battery cell 8 becomes higher than a set pressure to prevent an increase in the internal pressure. As the battery cell 8 described above, a secondary battery such as a nickel metal hydride battery or a lithium ion battery is adopted.

### Bus Bar Module (Not Shown)

The bus bar module includes a plurality of bus bars and a resin frame that holds the plurality of bus bars. The bus bar is formed by pressing a conductive metal plate. The bus bar is formed so as to be able to be connected to the electrode 10 of the battery cell 8 by nut fastening, welding or the like, that is, by a known method. In the resin frame, for example, a portion that supports the circuit board 7 is formed (shown is one example. The support of the circuit board 7 is not particularly limited).

### Smoke Exhaust Duct 6

In FIG. 1 and FIG. 2, the smoke exhaust duct 6 is formed as a portion that moves gas discharged (smoke-exhausted) from the valve 11 of the battery cell 8 to the outside in a direction away from the cell module 5 (in the present embodiment, the longitudinal direction (the alignment direction)). The smoke exhaust duct 6 is formed as a chimney portion extending in the longitudinal direction (the alignment direction). The smoke exhaust duct 6 has side walls 12 and 13 extending vertically (extending upwardly) with respect to the electrode arrangement surface 9 of the battery cell 8, and a ceiling wall 14 continuous to upper ends of the side walls 12 and 13, and is formed in a cross-sectional shape as shown in the drawing. The smoke exhaust duct 6 is formed in a shape to cover the valve 11 arranged in the longitudinal direction (the alignment direction) in a state having an internal space 15. The side walls 12 and 13 are formed to have different upward lengths (shown is one example. Examples having the same length will be described below). The ceiling wall 14 is formed in an inclined state non-parallel to the electrode arrangement surface 9. The ceiling wall 14 is formed at a portion where the circuit board 7 is arranged in a state of being inclined upward to the right shoulder as shown in the drawing and becomes an inclined mounting surface 16 for mounting. The ceiling wall 14 (the inclined mounting surface 16) is formed on a flat inclined surface. A plurality of screw holes (not shown) for fixing the board are formed on the ceiling wall 14 (the inclined mounting surface 16). The screw holes are formed at positions necessary for fixing the circuit board 7. The ceiling wall 14 (the inclined mounting surface 16) is formed such that the circuit board 7 can be easily arranged in the inclined state.

### Circuit Board 7

In FIG. 1 and FIG. 2, the circuit board 7 is provided in order to arrange, for example, a cell voltage monitoring IC (not shown) near the cell module 5. On an upper surface of the circuit board 7, various electronic components in addition to the cell voltage monitoring IC (a reference numeral 21 in FIG. 3A is one example among the components) are mounted. A wiring (not shown) is formed on the circuit board 7. Electronic components may be mounted on a lower surface of the circuit board 7 to reduce a dead space. The electronic components include, for example, a fuse, a resistor, a diode, a capacitor, and a thermistor. In the circuit board 7 of the present embodiment, a printed board on which the wiring is printed is adopted as a main body portion.

The circuit board 7 is arranged so as to cover the smoke exhaust duct 6 and the electrode arrangement surface 9 of the battery cell 8. The circuit board 7 is formed in a shape in which the middle of the circuit board 7 in the width direction is divided into two parts along the alignment direction. Specifically, the circuit board 7 includes a first divided-circuit-board 17, an second divided-circuit-board 18, and a connecting circuit body 19 connecting the first divided-circuit-board 17 and the second divided-circuit-board 18. The first divided-circuit-board 17 is formed with a wider width than the second divided-circuit-board 18. The first divided-circuit-board 17 and the second divided-circuit-board 18 are formed in rectangular shapes in plan view with different widths. The two divided portion of the first divided-circuit-board 17 and the second divided-circuit-board 18 is arranged to be on an upper end side of the smoke exhaust duct 6. That is, the first divided-circuit-board 17 and the second divided-circuit-board 18 are arranged in the inclined state. Opposite sides of the two divided portion (both end portions of the circuit board 7 in the width direction) are supported and fixed by appropriate structural portions, such as the resin frame of the bus bar module (not shown). The opposite sides are arranged near base ends of the electrodes 10 of the battery cell 8. That is, the opposite sides are arranged so as to approach the electrode arrangement surface 9 of the battery cell 8 (the arrangement described here and the arrangement illustrated in the drawings are merely examples. Although not shown in the drawings, the opposite sides may be arranged so as to cover the electrodes 10). The first divided-circuit-board 17 having the wide width is fixed to the inclined mounting surface 16 of the smoke exhaust duct 6 by a screw 20. The first divided-circuit-board 17 having the wide width is used to mount a component having a relatively wide width. The connecting circuit body 19 has flexibility. In the present embodiment, an FPC having the flexibility is adopted as the connecting circuit body 19. Communication between the first divided-circuit-board 17 and the second divided-circuit-board 18 is performed via the connecting circuit body 19. The connecting circuit body 19 is arranged at a position of the two divided portion. The circuit board 7 as described above is formed in a state where right triangle spaces exist on both sides of the smoke exhaust duct 6 with the smoke exhaust duct 6 as a center, that is, in a state illustrated as an inverted V-shape in cross section.

### Miniaturization and Reduction in Height

In FIG. 3A, an electronic component 21 having a relatively high height is mounted at a low position of the first divided-circuit-board 17 of the circuit board 7 (near an end portion of the circuit board 7 in the width direction). Since the first divided-circuit-board 17 is arranged in the inclined state, a height dimension H1 from the electrode arrangement surface 9 of the battery cell 8 to an upper end of the electronic component 21 is lower than that of a comparative example 1 shown in FIG. 3B. In FIG. 3B, a comparative example circuit board 22 is fixed on a comparative example smoke exhaust duct 23, and is formed so as to be parallel to the electrode arrangement surface 9. When the electronic component 21 is mounted on the comparative example circuit board 22 as described above, a height dimension H2 from the electrode arrangement surface 9 to the upper end of the electronic component 21 naturally increases due to a difference in board inclination (H1<H2). Therefore, it can be seen that the cover 4 (see FIG. 2) can be made relatively low, and conversely, the cover 4 in the comparative example 1 is high. Therefore, as a matter of course, a height of the entire battery module 2 can be reduced as compared with the comparative example 1, and a height of the battery pack 1 (see FIG. 2) can be reduced. As a result, it is possible to achieve the miniaturization and the reduction in height.

### Securing of Component Mounting Space

In FIG. 4A, the first divided-circuit-board 17 is arranged in the inclined state. Here, since a right triangle 24 shown in FIG. 4C is formed by an inclined side 25, an adjacent side 26, and an opposite side 27, the first divided-circuit-board 17 is arranged at a position corresponding to the inclined side 25. On the other hand, since circuit boards 28 and 28 in the comparative example 2 of FIG. 4B are arranged on both left and right sides of a comparative example smoke exhaust duct 23, it can be seen that the circuit boards 28 in the comparative example 2 are arranged at a position corresponding to the adjacent side 26 of the right triangle 24. Therefore, since the length of the adjacent side 26 is shorter than that of the inclined side 25, it is possible for the first divided-circuit-board 17 to secure a larger component mounting space than in the comparative example 2.

### Modification

In FIG. 5, the following modification is also effective. Specifically, a first divided-circuit-board 30 and a second divided-circuit-board 31 of a circuit board 29 are formed in a rectangular shape in plan view with the same width. A connecting circuit body 32 connecting the first divided-circuit-board 30 and the second divided-circuit-board 31 is arranged so as to cover a smoke exhaust duct 33. It is assumed that the smoke exhaust duct 33 is basically the same as the smoke exhaust duct 23 in the comparative example of FIG. 4B. The first divided-circuit-board 30 and the second divided-circuit-board 31 are arranged in an inclined state to the left and right with the smoke exhaust duct 33 as a center. In addition, as shown in FIG. 6, it is also possible to adopt a smoke exhaust duct 35 on which inclined mounting surfaces 34 for mounting the first divided-circuit-board 30 and the second divided-circuit-board 31 in an inclined state is formed.

### Effect

As described above with reference to FIG. 1, according to the battery pack 1 and the battery module 2 according to an embodiment of the present invention, since the circuit board 7 is arranged in an inclined state, by mounting the electronic component 21 having a relatively high height at a low position on the circuit board 7 in the inclined state, the height of the entire battery module 2 can be made lower than in the related art. That is, it is possible to achieve the miniaturization and the reduction in height. Further, according to the battery pack 1 and the battery module 2, since the circuit board 7 is arranged in the inclined state, it is possible to secure a larger component mounting space on the circuit board 7 than in the related art.

It goes without saying that the present invention can be variously modified without departing from the spirit of the invention.

### DESCRIPTION OF REFERENCE NUMERALS AND SIGNS

1 battery pack

2 battery module

3 case

4 cover

5 cell module

6 smoke exhaust duct

7 circuit board

8 battery cell

9 electrode arrangement surface

10 electrode

11 valve

12, 13 side wall

14 ceiling wall

15 internal space

16 inclined mounting surface

17 first divided-circuit-board

18 second divided-circuit-board

19 connecting circuit body

20 screw

21 electronic component

22 comparative example circuit board

23 comparative example smoke exhaust duct

24 right triangle

25 inclined side

26 adjacent side

27 opposite side

28, 29 circuit board

30 first divided-circuit-board

31 second divided-circuit-board

32 connecting circuit body

33 smoke exhaust duct

34 inclined mounting surface

35 smoke exhaust duct

What is claimed is:

1. A battery module comprising:
a cell module including a plurality of battery cells;
a smoke exhaust duct protruding from an electrode arrangement surface of the cell module and extending along an alignment direction of the plurality of battery cells, and
a circuit board arranged so as to cover the smoke exhaust duct and the electrode arrangement surface,
wherein the circuit board is arranged in an inclined state to be non-parallel to the electrode arrangement surface.

2. The battery module according to claim 1,
wherein the circuit board is divided along the alignment direction and includes a first divided-circuit-board and a second divided-circuit-board,
wherein a divided portion of the circuit board is arranged on an upper end side of the smoke exhaust duct.

3. The battery module according to claim 2,
wherein the first divided-circuit-board has a wider width than that of the second divided-circuit-board in a width direction orthogonal to the alignment direction.

4. The battery module according to claim 2,
wherein the first divided-circuit-board and the second divided-circuit-board are connected by connecting circuit body having flexibility.

5. The battery module according to claim 1,
wherein the smoke exhaust duct has an inclined mounting surface on which the circuit board is arranged in the inclined state and mounted.

6. A battery pack comprising:
the battery module according to claim 1;
a case accommodating the battery module, and
a cover covering the case.
